(19) United States
(12) Patent Application Publication
(10) Pub. No.: US 2009/0109489 A1
(43) Pub. Date: Apr. 30, 2009

(54) PAGE OF A PRINT WORK WITH A FOLDABLE INDICATOR SECTION FOR MARKING THE PAGE

(76) Inventor: Anton Schleiter, Hamburg (DE)

Correspondence Address: BACHMAN & LAPOINTE, P.C., 900 CHAPEL STREET, SUITE 1201, NEW HAVEN, CT, 06510, US

(21) Appl. No.: 12/259,306

(22) Filed: Oct. 28, 2008

(30) Foreign Application Priority Data
Oct. 29, 2007 (DE) 20 2007 015 197.7
Jun. 2, 2008 (DE) 20 2008 007 461.4
Jun. 6, 2008 (DE) 20 2008 007 736.2
Jul. 21, 2008 (DE) 20 2008 009 799.1

(51) Int. Cl. G06K 15/02

(52) U.S. Cl. 358/1.18

(57) ABSTRACT

A page of a print work has a foldable indicator section for marking the page, wherein the indicator section, in the folded state, at least partially protrudes beyond a page edge. To provide a page of a print work and a print work which enables marking of the page without additional auxiliary devices, wherein handling of a print work produced of the pages is not hindered by the indicator section, it is provided that the indicator section is partially separated from the page by a recess, wherein opposite edges of the recess are arranged at a distance from each other.

### BACKGROUND

(1) Field of the Invention

The invention relates to a page of a print work with a foldable indicator section for marking the page wherein, in the folded state, the indicator section at least partially protrudes beyond one edge of the page. The invention relates further to a print work with at least one page comprising an indicator section integrally formed with the page.

(2) Prior Art

Generic pages of the initially mentioned type are combined in a print work of the initially mentioned type by creating a common binding. Print works are, amongst others, catalogues, prospectuses, books, writing pads, magazines, reference books, diaries or similar works, which in principle have more than one page.

During the perusal or reading of a print work, whether a catalog, a prospectus, a book or the like, the reader keeps encountering the problem that he wants to indicate or mark certain pages to enable quick and easy finding of one or more pages again. In a book, the mark is usually to indicate current reading progress. In prospectuses and catalogues or the like, pages with interesting products or information can be made visible from the outside, i.e. also in the closed state of the print work by marking them.

Apart from the well-known loose bookmarks or sticky labels, which make it necessary to keep a certain number of sticky labels ready when perusing or reading the print work, the generic DE 2935947 C2 suggests a tab integrally formed with a page of the print work for marking purposes. This configuration has the drawback, however, that the tabs, which protrude beyond the edge of the page and thus mark it by folding along a separating line, have to be partially separated from the page before folding. This separating process, which can only be carried out using both hands, in spite of any perforation present, leads to recurrent further undesirable damage of the page.

From U.S. Pat. No. 2,300,632, a book mark integrally formed with a page of a book is also known, wherein the indicator section functioning as the bookmark is already partially separated from the page by a cut. This configuration has the drawback, however, that during the handling of the print work, in particular during fast leafing with a thumb usually abutting against the longitudinal edge of the print work, but also during normal turning of the page, the pages keep catching in the area of the cuts.

### SUMMARY OF THE INVENTION

It is the object of the present invention to provide a page of a print work, and a print work produced using the page, which enables marking the page without additional auxiliary means, wherein at the same time handling of a print work produced from the pages is not hindered by the indicator section.

The invention solves the object by a page of a print work having a foldable indicator section for marking the page, wherein the indicator section at least partially protrudes beyond a page edge in a folded state, wherein the indicator section is partially separated by from the page by a recess and wherein opposite edges at the recess are arranged at a distance from each other and a print work with at least one page with an indicator section integrally formed with the pages.

The inventive page of a print work is characterized in that the indicator section is partially separated from the page by a recess, wherein opposite edges of the recess are arranged at a distance from each other.

The indicator section which is an integral part of the page is partially separated from the page. The separation is thereby formed by a recess which is created, for example, by a stamping, milling, cutting or laser process. A crucial feature of the recess does not reside in its basic manufacturing method, but that the opposite edges of the recess do not lie adjacent to each other as with a simple cut, but are arranged at a distance from each other.

The configuration according to the present invention ensures that a print work produced using the pages according to the present invention, has the same properties as a print work not provided with indicator sections or recesses when turning the pages. At the same time, however, there is a possibility to mark certain pages by folding the indicator section along a folding line, wherein, in the folded state, the indicator section at least partially protrudes beyond an edge of a page. This enables a page thus marked to be found even in the closed state of the print work in a simple manner, and to be opened again immediately. Moreover, the page can be returned into its original state by simply folding back the indicator section, wherein then, in particular, due to the spacing between the edges of the recess, catching with adjacent pages can still be reliably prevented.

The orientation of the recess on the page is basically freely selectable. Further, it is not always necessary for the recess to extend to an edge of the page. It is conceivable to arrange the recess in such a way that it is completely surrounded by the page wherein, in the area of the page edge, preferably only a small area remains which can be separated when the marking is needed. According to a particularly advantageous embodiment of the invention, the recess extends up to a page edge, however, i.e. it is no longer completely surrounded by a page of the print work. This embodiment of the invention is characterized in that, as a result of the spaced edges of the recess smooth usage of the print work is still possible while, at the same time, in a particularly simple manner, using just one hand, the indicator section can be immediately folded without preparatory work. This embodiment of the invention enhances the ease of use of a print work produced using these pages in a complementary manner.

As already mentioned, the orientation of the recess on the page is basically freely selectable. According to an advantageous embodiment of the invention, the recess is arranged, however, essentially in parallel to a page edge. This embodiment of the invention ensures that the indicator section in the folded state is essentially at right angles to the page edge, to which the recess is parallel and beyond which the indicator section protrudes. This ensures that the print work has an aesthetically pleasing, in particular tidy, outward appearance even if the indicator sections of some of the pages have been folded. Moreover, the stability of the pages both for quick and for normal leafing is maintained, which effectively prevents damage.

Basically, the recess can also be arranged in the area of a lower page edge, in the orientation of usage, for instance parallel to the latter. In a particularly advantageous manner, however, the recess is arranged in the area of a top page edge and parallel to it. A print work having pages formed in the corresponding manner has the advantage that even in an upright position of the print works, namely in the usual storage position on shelves of print works, in particular books, but also catalogues or the like, the indicator sections protrude on top, are easily visible from the outside and are protected against damage from contact with shelves in the storage condition. The recess extending orthogonal to a binding edge according to this embodiment prevents in a complementary manner catching of a print work produced from these pages even if the individual pages shift with respect to one another during leafing.

According to a further embodiment of the invention, the recess is arranged in such a manner that the indicator section in the folded state partially protrudes beyond two page edges in the area of a page corner. According to this embodiment of the invention a page is immediately visible to the user both when looking at a longitudinal edge and when looking at a top or bottom page edge. This embodiment thus facilitates in a complementary manner finding marked pages of a print work produced using these pages. The arrangement of the recess and a fold line, if any, ensures that in the folded state, the indicator section protrudes beyond two page edges.

As initially mentioned, the configuration of the recess is basically freely selectable and can have for example a v-form or a rectangular form. According to a particularly advantageous embodiment of the invention, however, the bottom of the recess, i.e. that area in which the opposite edges are joined, has a u- or oval form. This configuration of the bottom of the recess results in particularly easy foldability of the indicator section, wherein it is ensured at the same time that the page does not tear beyond the bottom of the recess.

Particularly advantageously, the distance between the edges of the recess is locally greater in the area of the bottom of the recess than in the remaining area. It is thus provided that the edges of the recess extending essentially at the same distance have a greater distance in the area of the bottom of the recess. This can be achieved, for example, by separately forming the bottom of the recess, particularly advantageously by means of stamping, which has different geometric forms, particularly advantageously a circular form. This embodiment of the invention ensures in a complementary manner, that there is no damage when the indicator section is folded, i.e. it prevents in a particularly effective manner tearing of the pages both during folding of the indicator section and when it is folded back.

According to a further embodiment of the invention, the page has a reinforcement in the area around the bottom of the recess. This reinforcement which can, as a rule, be limited to a small area around the bottom of the recess due to the localized stresses when the indicator section is folded, ensures in a complementary manner that when the indicator section is folded or folded back again there is no damage to the page in the area of the bottom of the recess.

The configuration of the reinforcement, which is preferably configured in such a way that there is no thickening of the page in this area, is basically freely selectable. According to a particularly advantageous embodiment of the invention, however, the reinforcement is realized by means of a coating, a higher paper quality in areas compared with the remaining page and/or a film. Particularly the production of the reinforcement by means of a coating, for example a lacquer, which can be applied in liquid form, or a film, is advantageous in that it can be applied in a particularly cheap manner. Moreover, a reinforcement formed in such a way can also be applied later, i.e. after producing the page, including the recess.

Basically it is sufficient for the function of the page according to the present invention if a recess is provided. Then folding can be along a folding line formed by one hand. According to a particularly advantageous embodiment of the invention, the page has a preformed fold-line along which the indicator section can be folded. This is to ensure in a complementary manner that all indicator sections have essentially the same orientation in the folded state which helps to maintain the aesthetic outward appearance of the print work also in a state with folded indicator sections. The fold line also facilitate folding back the indicator section to its flat original state.

According to a further embodiment of the invention, the indicator section is offset from the rest of the page by means of color and/or has a symbol and/or a text. A corresponding further developed indicator section has the advantage that it is optically better offset from the page edges in the folded state—in particular in the case of a colored design which is distinguished from the rest of the page. In the non-folded state, the indicator section is more easily visible to the user. The arrangement of texts, such as page numbers and/or symbols, which can be arranged as a complement to a colored design, but which can also be there alone, makes it possible to provide information for the user on the indicator section which can also be seen in the closed state of the print work. The symbols and/or the text can also refer to the contents of the marked page.

According to a further embodiment of the invention, the edges of the recess have a profile. In the folded state, the indicator section partially protrudes beyond the page edge, wherein one edge of the recess forms a lateral edge of the indicator section protruding beyond the edge. The profile of this edge facilitates handling, in particular, by providing enhanced grip of the indicator section in a complementary manner.

It is characterizing for the print work according to the present invention, that it has at least one page according to the claims. Such a print work is further distinguished by its ease of handling, while providing at the same time a simple way of marking desired pages.

### BRIEF DESCRIPTION OF THE DRAWINGS

Exemplary embodiments of the invention will be described in the following with reference to the drawings in more detail. In the drawings:

FIG. 1 is a perspective view of a print work formed of pages with foldable indicator sections with opened binding;

FIG. 2 is a perspective view of the print work of FIG. 1 in a closed state;

FIG. 3 is a perspective view of the print work of FIG. 1 with pages with folded indicator sections in an opened state;

FIG. 4 is a perspective view of the print work of FIG. 3 in a closed state;

FIG. 5 shows one page of a print work in a plan view;

FIG. 6 is a front view of the page of FIG. 5 with an indicator section folded to the back;

FIG. 7 is a front view of the page of FIG. 5 with the indicator section folded to the front;

FIG. 8 shows a corner of a page with a first embodiment of a recess;

FIG. 9 shows a corner of a page with a second embodiment of the recess; and

FIG. 10 shows a corner of a page with a third embodiment of the recess.

### DETAILED DESCRIPTION OF THE PREFERRED EMBODIMENT(S)

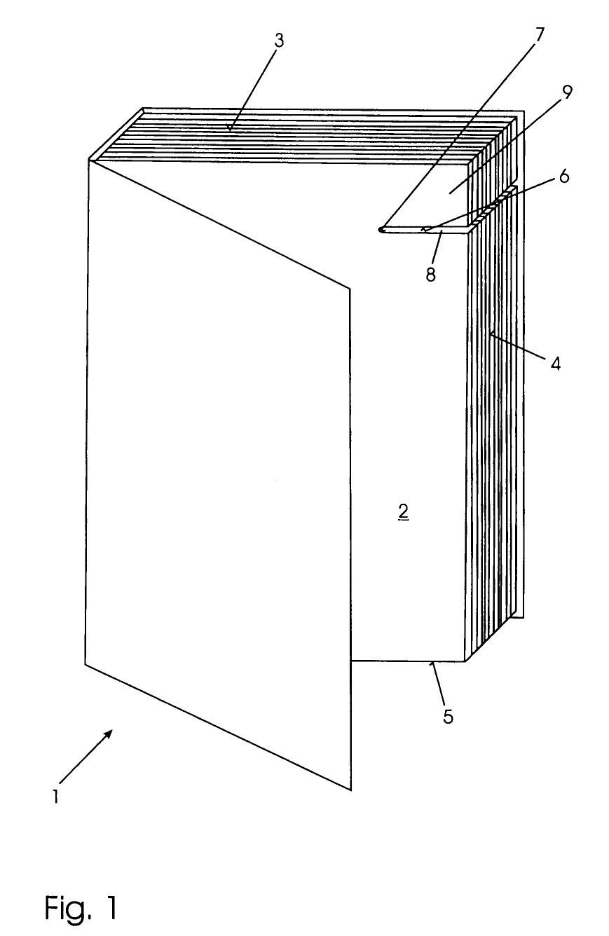

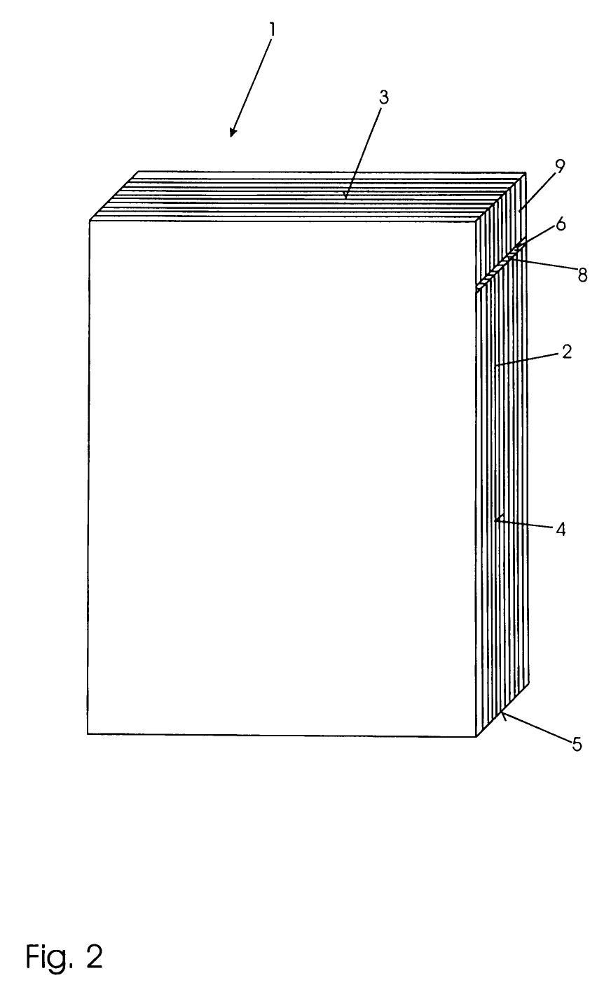

FIGS. 1 and 2 show a print work 1 formed of pages 2 in an open (FIG. 1) or closed (FIG. 2) state. Pages 2 are bound along a longitudinal edge and, in the area of one corner, have a recess 8 extending parallel to a top page edge 3.

Recess 8 extends up to a longitudinal edge 4 of page 2 and has two edges 6 arranged opposite each other and spaced from each other. Edges 6 are joined in the area of bottom 7 of the recess. Recess 8 forms an indicator section 9 which is partially separated from page 2.

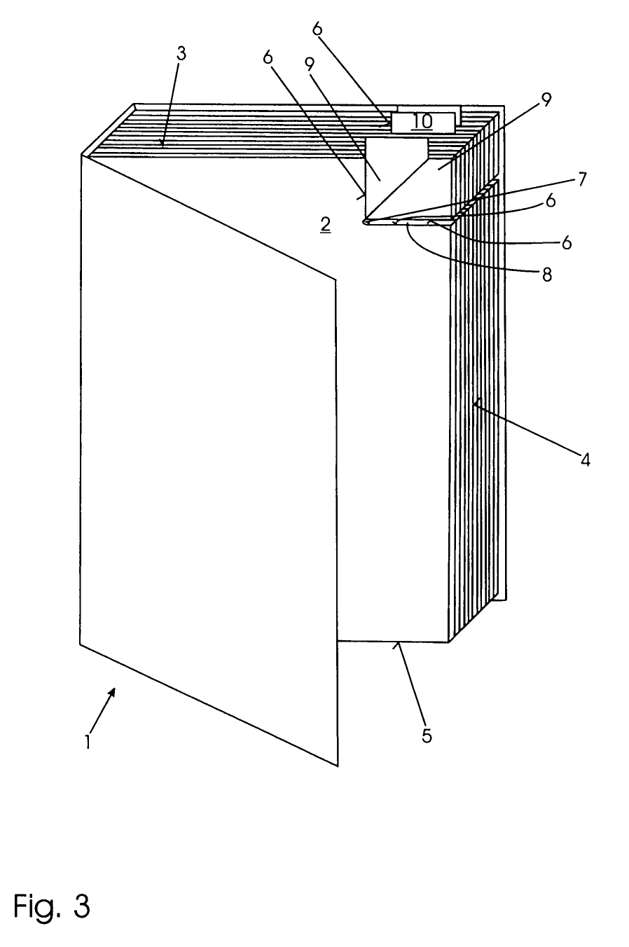

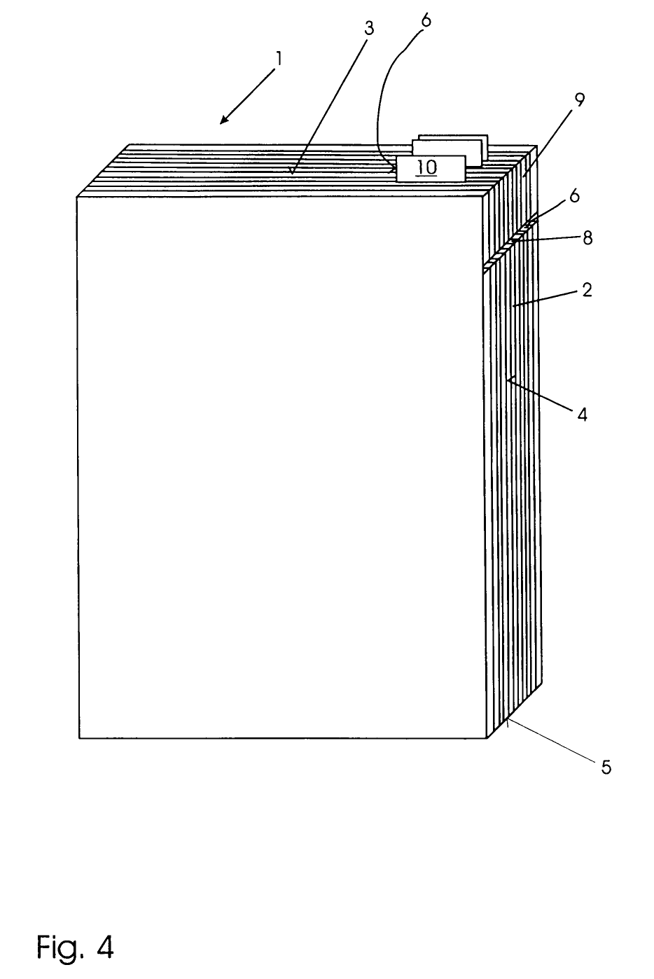

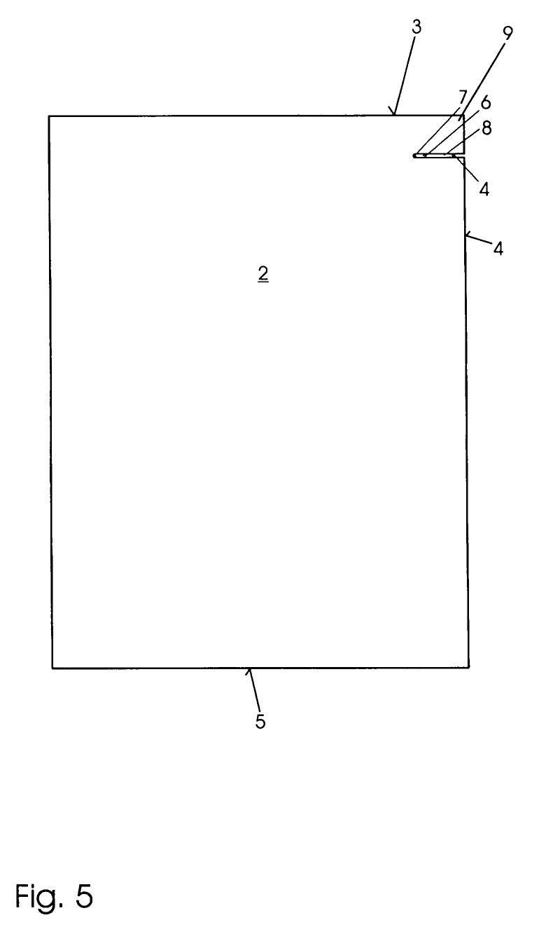

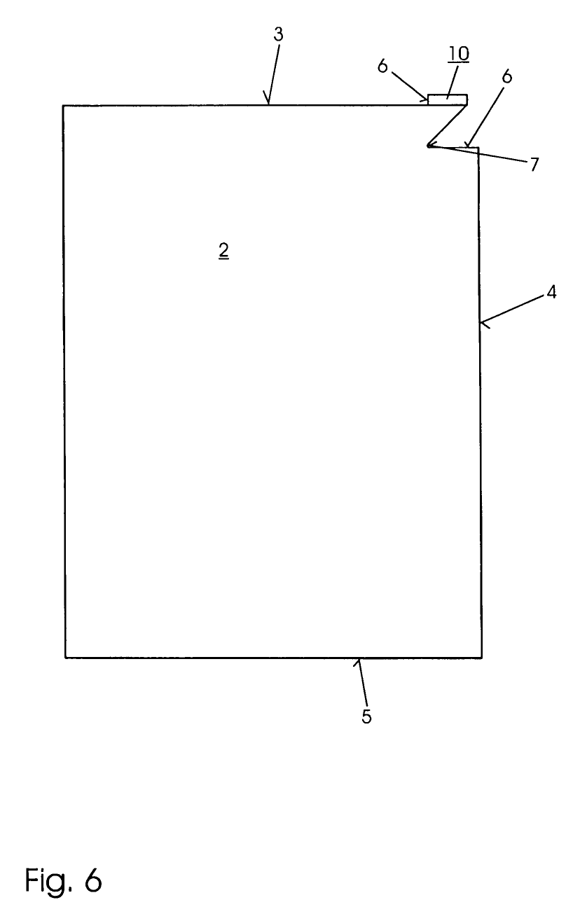

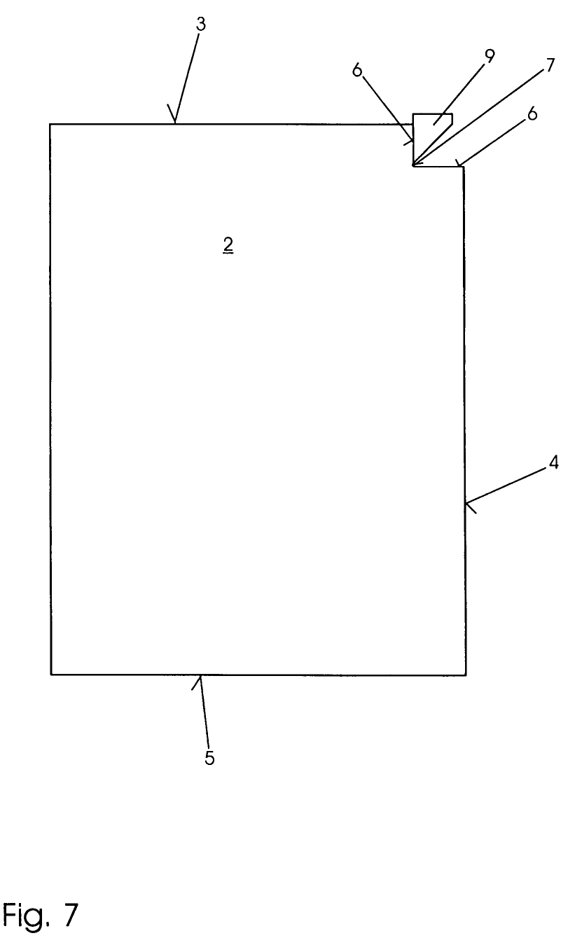

For marking individual pages 2 of print work 1, indicator section 9 can be folded along a fold line extending essentially at an angle of 45° with respect to recess 8, the fold line extending from the top side edge 3 to a bottom 7 of the recess 8. This is how an area 10 of indicator section 9 protrudes beyond top side edge 3 also in the closed state of print work 1 so that the relevant page 2 is visible from the outside also in the closed state of print work 1 (cf. FIGS. 3-7).

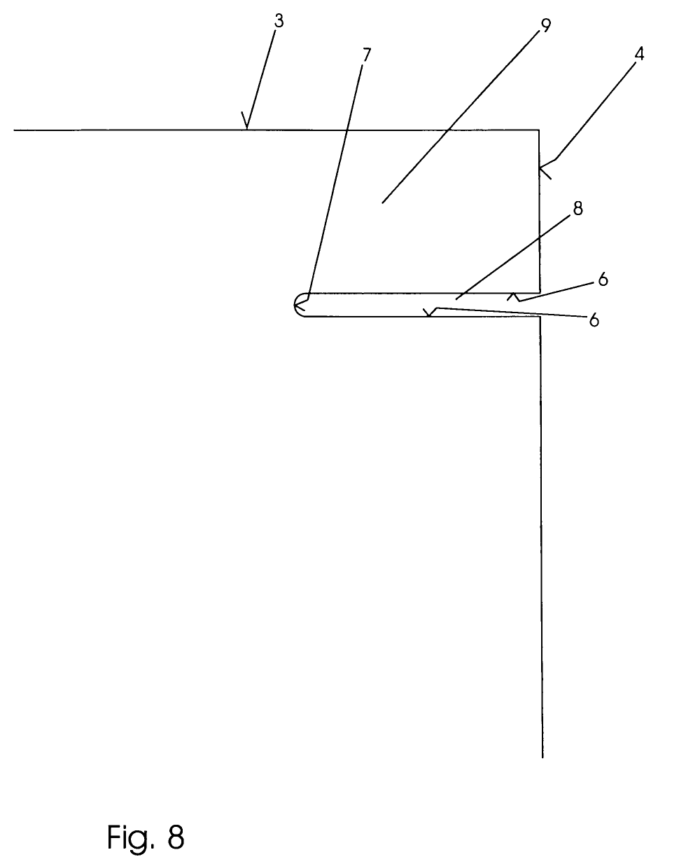

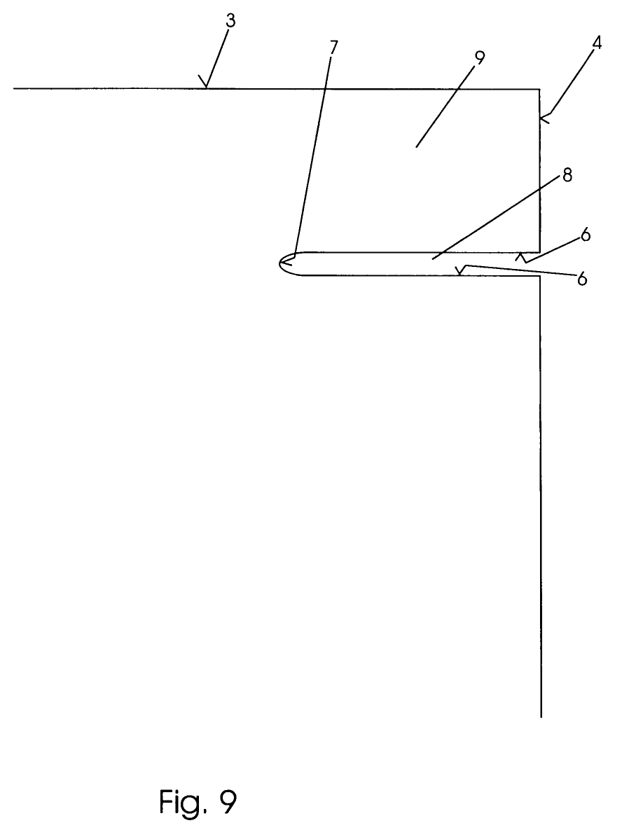

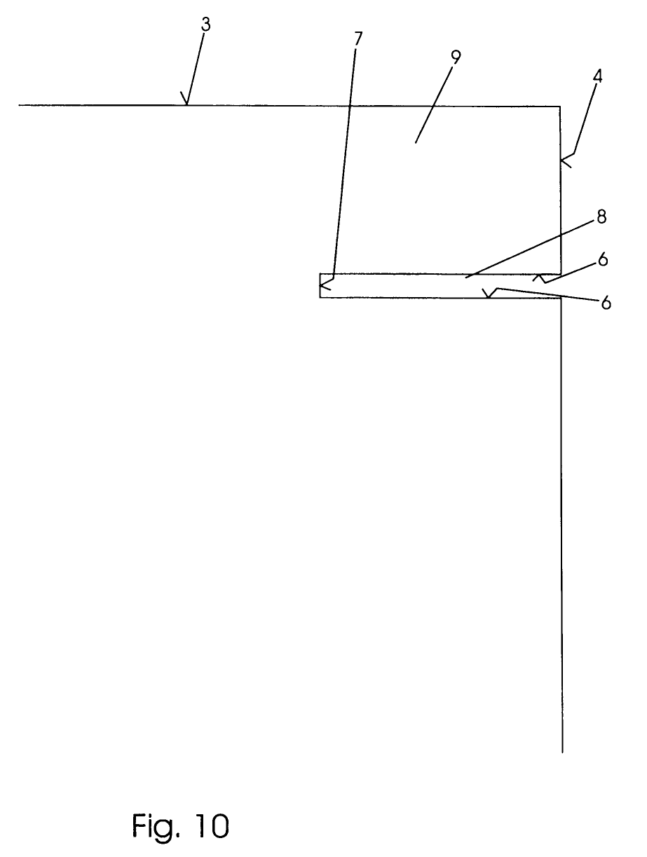

The configuration of recess 8, which is advantageously formed by material-removing stamping, lasering or cutting, in particular the configuration of bottom 7 of the recess is basically freely selectable. In FIGS. 8-10, three different embodiments of a recess 8 are shown, each having different bottoms 7. Recess 8 shown in FIG. 8 has a u-shaped bottom, recess 8 shown in FIG. 9 has an oval-shaped bottom, and recess 8 shown in FIG. 10 has a rectangular bottom 7 of the recess.

1-15. (canceled)

16. A page of a print work having a foldable indicator section for marking the page, wherein the indicator section in a folded state at least partially protrudes beyond a page edge, wherein the indicator section is partially separated from the page by a recess and wherein opposite edges of the recess are arranged at a distance from each other.

17. The page according to claim 16, wherein the recess extends up to one of a plurality of page edges.

18. The page according to claim 16, wherein the recess is arranged essentially in parallel to one of a plurality of page edges.

19. The page according to claim 16, wherein the recess is arranged in parallel to a top page edge in an area of the latter.

20. The page according to claim 16, wherein the recess is arranged in such a way that the indicator section, in the folded state, partially protrudes beyond two page edges in an area of a page corner.

21. The page according to claim 16, wherein a bottom of the recess has one of a u-shape and an oval shape.

22. The page according to claim 16, wherein an area of a bottom of the recess, the distance between edges of the recess is locally greater than in a remaining area.

23. The page according to claim 16, wherein a bottom of the recess is formed by one of stamping, milling, lasering and cutting, and wherein the bottom has a circular configuration.

24. The page according to claim 16, wherein an area around a bottom of the recess has a reinforcement.

25. The page according to claim 24, wherein the reinforcement is formed by a coating, a higher paper quality in areas compared to the rest of the page and/or by a film.

26. The page according to claim 16, wherein a fold line of the indicator section is preformed.

27. The page according to claim 16, wherein the indicator section is offset from the rest of the page by color and/or has a symbol and/or a text.

28. The page according to claim 16, wherein edges of the recess have a profile.

29. A print work with a page according to claim 16, wherein the distance between the edges of the recess is from 0.1-2 mm.

30. A print work according to claim 16, wherein the distance is in the range of from 0.3 to 1.3 mm.

31. A print work according to claim 16, wherein the distance is in the range of from 0.5 to 0.8 mm.

32. A print work with at least one page with an indicator section integrally formed with the page, wherein the page (2) is formed according to claim 16.
